(19) United States
(12) Patent Application Publication
(10) Pub. No.: US 2008/0055101 A1
(43) Pub. Date: Mar. 6, 2008

(54) Location Tracking System And A Method Of Operating Same

(75) Inventor: Hau Leung Stephen Chung, Hong Kong (CN)

Correspondence Address: BUCHANAN, INGERSOLL & ROONEY PC, POST OFFICE BOX 1404, ALEXANDRIA, VA, 22313-1404, US

(73) Assignee: Intexact Technologies Limited, Hong Kong (CN)

(21) Appl. No.: 10/515,329

(22) PCT Filed: Mar. 19, 2004
(86) PCT No.: PCT/CN04/00225

§ 371 Date: Sep. 29, 2005

(51) Int. Cl. G08B 1/00

(52) U.S. Cl. 340/686.1; 348/42; 381/92

(57) ABSTRACT

A location tracking system for tracking the location of a person in a premises is disclosed as including a plurality of location sensing devices for assessing the location of the person in the premises; a number of closed circuit television cameras for obtaining visual images of the person; a visual display monitor connected with and receive signals from only one of the closed circuit television cameras at a time; and the visual display monitor is connected with the closed circuit television camera with the higher/highest score of suitability, as calculated in a pre-determined manner. A method of operating a location tracking system for tracking the location of a person in a premises is disclosed as including the steps of (a) providing a number of location sensing devices for assessing the location of the person in the premises; (b) providing a number of closed circuit television cameras for obtaining visual images of the person; (c) providing a visual display monitor for connecting with and receiving signals from only one of the closed circuit television camera at a time; and (d) calculating, in a pre-determined manner, a score of suitability for each of the closed circuit television cameras; and (e) connecting the visual display monitor with the closed circuit television camera with the higher/highest score of suitability.

The present invention relates to a location tracking system and, in particular, such a system for tracking the movement of a moving object, e.g. an individual in a premises, and operating various electrical and/or electronic appliances connected to the system in response to the movement of the object.

In a typical security setup, a premises may be monitored by one or more closed-circuit television (CCTV) cameras. These cameras are wired into a video chooser, which allows a user to choose to watch video images captured by a particular camera by manually selecting that channel, or into a video sequencer, which flips through the cameras in sequence at a pre-set interval and in a pre-defined order.

Thus, typically, to monitor the premises, the user has to manually switch among different cameras as a person walks through the premises. The person being monitored thus always falls out of sight of some cameras and falls into sight of some others. In order to track the movement of that person through the premises, the user must not only remember where each camera is, but he must also guess, based on the person's travel direction, which camera is likely to show the person being monitored, after his image has fallen out of sight of the current camera being viewed. In a situation where the user makes a wrong guess and the new camera chosen does not show the person being monitored, the user has to resort to manually flipping through all the cameras in sequence in order to locate the person again. Sometimes this may not be possible, especially if the person is a resourceful intruder.

If there are other devices installed in the premise, e.g. speakers, the user may also wish to speak to the person being monitored, e.g. to issue a warning or to provide directions. The user must then manually switch-connect his microphone to the set of speakers closest to the person, based on where the person is located, which is made known by viewing his image with a camera. Again, the user must remember where the speakers are and which speakers match which particular camera in each particular area. When the person's image is lost on the current selected camera, then all is lost.

It is thus an object of the present invention to provide a location tracking system and method in which the aforesaid shortcomings are mitigated, or at least to provide a useful alternative to the public.

It is a further object of the present invention to provide a location tracking system and method built upon an intelligent, integrated platform installed in a premises which can provide automatic tracking of an object moving through the premises, and will allow the user to maintain contact with the object throughout the trip, if necessary.

According to a first aspect of the present invention, there is provided a location tracking system for tracking the location of at least one moving object, including a plurality of location sensing devices adapted to assess the location of said object; at least two signal receivers adapted to capture signals of and/or relating to said object; an output device adapted to be connected with and receive signals from only one of said at least two signal receivers at a time for output; and means adapted to connect said output device with said signal receivers with the higher/highest score of suitability, as calculated in a pre-determined manner.

According to a second aspect of the present invention, there is provided a method of operating a location tracking system for tracking the location of at least one moving object, including the steps of (a) providing a plurality of location sensing devices adapted to assess the location of said object; (b) providing at least two signal receivers adapted to capture signals of and/or relating to said object; (c) providing an output device adapted to be connected with and receive signals from only one of said at least two signal receivers at a time for output; (d) calculating, in a pre-determined manner, a score of suitability for each of said at least two signal receivers; and (e) connecting said output device with the signal receiver with the higher/highest score of suitability.

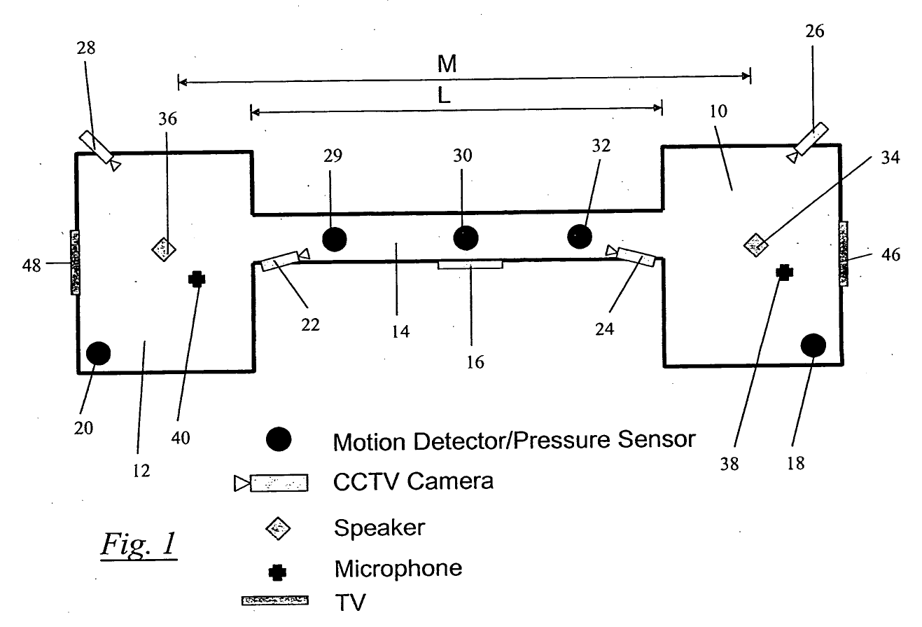

Embodiments of the present invention will now be described, by way of examples only, and with reference to the accompany FIG. 1, which shows schematically a premises installed with a location tracking system according to the present invention. It should be particularly noted that while the present invention is herein described in the context of a system and a method as used in a premises, it should be understood that the scope of the invention is not so limited, and the invention can be applied and implemented in other circumstances.

In a location tracking system according to the present invention, a database of installed devices, e.g. CCTV cameras, speakers, microphones, motion detectors, magnetic contact switches, installed in the system is kept in a storage media, e.g. hard disc, of the system, detailing the location of each device, as well as other orientational parameters, e.g. viewing direction. This database may be stored in a hard disc in the aforementioned data processing apparatus, e.g. a personal computer, forming part of the intelligent, integrated platform. At the user's end are provided with a video monitor, a microphone and speakers. The installed devices in the premises and the user's video monitor, microphone and speakers are connected with one another and with the above-mentioned data processing apparatus via a digital communication backbone, e.g. in a system as described in more details in Hong Kong Short-Term Patent No. HK1052830 (the full content of which being hereby fully incorporated herein as if fully repeated here), although it should be understood that the various devices may be connected with one another via a less sophisticated infrastructure.

The motion detectors and magnetic contact switches allow the system to determine where the person is, based on his/her motion and/or opening/closing of doors. Other types of detection sensors, such as pressure sensors mounted beneath floor tiles, may also be installed.

When the system receives a signal from any detector indicating the location of the person being monitored, it will:
1. run through all CCTV cameras to select the one most likely to provide the best video image of the person based on its location (e.g. ignoring cameras in another room), viewing direction (e.g. ignoring cameras pointing at the opposite direction), and position (e.g. ignoring cameras mounted too high). If two or more cameras fit these requirements, then the one closest to the location of the person will be selected to provide the clearest image;
2. run through all audio speakers to select the one closest to the person based on its location and position, ignoring speakers in another room, as that cannot be heard. If two or more speakers fit these requirements, then the one closest to the location of the person will be selected; and
3. run through all microphones to select the one closest to the person based on its location and position, ignoring microphones in another room. If two or more microphones fit these requirements, then the one closest to the location of the person will be selected.

A score is calculated for each device based primarily on its distance from the person's perceived location, while eliminating all choices that are clearly inappropriate, e.g. those devices pointing at a wrong direction, or in another room etc. The device with the highest score for each type will be selected.

The system then automatically switch-connects the user's video monitor to the selected CCTV camera, the user's microphone to the selected speaker, and the user's speakers to the selected microphone. Thus the user can always maintain contact with the person being monitored, all the while communicating with him, without having to guess through which camera the person is likely to show up next. The system automatically takes care of tracking the person's location (based on installed detectors and sensors) and maintaining a continuous video and/or audio link for the user.

In order to prevent frequent rapid flipping between cameras, microphones and speakers when the person being monitored moves to a borderline location covered by two devices or two sets of devices, a threshold system is provided. Switching will not be performed if the score of the currently selected device or set of devices is above a pre-defined threshold level, even though there is an alternative, better choice of device or set of devices with an even higher score. Switching will only be performed if the person moves away from the borderline for a sufficient distance so that the score of the currently selected device or set of devices falls under the threshold level.

A premises installed with a location tracking system according to the present invention is shown in FIG. 1, and consists of a room 10 and a room 12 connected by a common corridor 14. A person, e.g. a workman delivering goods to the premises, enters through an elevator opening 16 in the middle of the corridor 14, and may either turn left to the room 12 or turn right to the room 10. Within the premises are installed a number of sensors and communication devices, including motion detectors, CCTV cameras, speakers and microphones. Motion detectors 18 and 20 are triggered whenever a person moves within the room 10 and the room 12 respectively. The corridor 14 is also paved with pressure sensing floor tiles 29, 30, 32, which serve as pressure sensors, and thus location-tracking devices, for determining the relative position of the person within the corridor 14. Other suitable location-tracking devices, such as spaced photo beams, or microwave range detectors etc., may also be used.

Let us assume that the devices are pre-set with the attributes as shown in the following Table 1.

TABLE 1

| Device | Zone Restriction | Scoring formula | Threshold |
|---|---|---|---|
| CCTV 22 | Corridor 14 | $1 - \frac{2 D}{L}$ | −0.3 |
| CCTV 24 | Corridor 14 | $1 - \frac{2 D}{L}$ | −0.3 |
| CCTV 26 | Room 10 | 1 | — |
| CCTV 28 | Room 12 | 1 | — |
| Motion Detector 18 | Room 10 | — | — |
| Motion Detector 20 | Room 12 | — | — |
| Pressure Sensor 28 | Corridor 14 | — | — |
| Pressure Sensor 30 | Corridor 14 | — | — |
| Pressure Sensor 32 | Corridor 14 | — | — |
| Speaker 34 | — | $1 - \frac{2 D}{M}$ | −0.2 |
| Speaker 36 | — | $1 - \frac{2 D}{M}$ | −0.2 |
| Microphone 38 | — | $1 - \frac{2 D}{M}$ | −0.2 |
| Microphone 40 | — | $1 - \frac{2 D}{M}$ | −0.2 |

Each device is restricted to operate only in its designated zone. Therefore, for instance, the CCTV 22 will not be considered at all (i.e. the score will always be zero) when the person's location is not in the corridor.

In the above Table 1, “D” represents the distance between the location of the person and the location of the respective device. Since motion detectors cannot locate with certainty where the person is, an approximation may be used. For example, if the motion detector 18 is triggered, the person's location is assumed to be at the center of the room 10. Similarly, if the motion detector 20 is triggered, the person's location is assumed to be at the center of the room 12.

In more complex implementations, the scoring formulae for CCTV's may even contain terms specifying the angle and field of view, plus other factors that may affect the quality of the video image of the person.

Notice that speakers 34 and 36 and the microphones 38 and 40 do not have restricted zones. This is because they are considered loud enough and sensitive enough to cover the entire premises.

When a person exits the elevator 16, the system determines (from the pressure sensing floor tiles) that the location of the person is in the middle of the corridor 14. The zone activated is therefore “Corridor”, and all devices that are restricted to a zone other than “Corridor” will not be considered.

“D”, the distance of the person from the CCTV 22 and CCTV 24 respectively, is the same value for both devices, which is L/2. “D” to each of the speakers 34, 36 and microphones 38, 40 is M/2. As shown in the following Table 2, the scores of all the devices at this point of time are zeros throughout:

TABLE 2

| Device | “D” | Scoring formula | Score |
|---|---|---|---|
| CCTV 22 | $\frac{L}{2}$ | $1 - \frac{2 D}{L}$ | 0 |
| CCTV 24 | $\frac{L}{2}$ | $1 - \frac{2 D}{L}$ | 0 |
| CCTV 26 | — | 1 | — |
| CCTV 28 | — | 1 | — |
| Speaker 34 | $\frac{M}{2}$ | $1 - \frac{2 D}{M}$ | 0 |
| Speaker 36 | $\frac{M}{2}$ | $1 - \frac{2 D}{M}$ | 0 |
| Microphone 38 | $\frac{M}{2}$ | $1 - \frac{2 D}{M}$ | 0 |
| Microphone 40 | $\frac{M}{2}$ | $1 - \frac{2 D}{M}$ | 0 |

Since all scores are the same, the system may either pick devices randomly or it may simply select the first available choice. For this instance, assume that the CCTV 22, the speaker 36 and the microphone 40 are chosen, so that the CCTV 22 will be connected to the user's video monitor, the speaker 36 will be connected to the user's microphone and the microphone 40 will be connected to the user's speakers. The user will thus see the left side of the person from the CCTV 22, and the person will hear the user's voice through the speaker 36 on his left.

Now assume that the person turns right towards the room 10. Immediately, the scores begin to change since the location of the person has changed. The system determines the position of the person based on signals received from the pressure-sensing floor tiles 29, 30 and 32, as appropriate. The system continuously updates all scores based on the location of the person. For example, Table 3 below shows the scores of the various devices when the person is at a distance of 0.1L to the right of the elevator 16.

TABLE 3

| Device | “D” | Scoring formula | Score |
|---|---|---|---|
| CCTV 22 | 0.6 L | $1 - \frac{2 D}{L}$ | −0.2 |
| CCTV 24 | 0.4 L | $1 - \frac{2 D}{L}$ | 0.2 |
| CCTV 26 | — | 1 | — |
| CCTV 28 | — | 1 | — |
| Speaker 34 | $\frac{M}{2} - 0.1 L$ | $1 - \frac{2 D}{M}$ | $0.2 \frac{L}{M}$ |
| Speaker 36 | $\frac{M}{2} + 0.1 L$ | $1 - \frac{2 D}{M}$ | $- 0.2 \frac{L}{M}$ |
| Microphone 38 | $\frac{M}{2} - 0.1 L$ | $1 - \frac{2 D}{M}$ | $0.2 \frac{L}{M}$ |
| Microphone 40 | $\frac{M}{2} + 0.1 L$ | $1 - \frac{2 D}{M}$ | $- 0.2 \frac{L}{M}$ |

$Since L < M , \frac{L}{M} < 1 , and thus ( 0.2 \frac{L}{M} ) < 0.2 .$

There is now a set of devices, namely the CCTV 24, the speaker 34 and the microphone 38, which have higher scores than those of the currently selected set of devices, i.e. the CCTV 22, the speaker 36 and the microphone 40. However, since the scores of the current set of devices

$$( - 0.2 and - 0.2 \frac{L}{M} )$$

are not below their respective thresholds (i.e. −0.3 and −0.2, as per Table 1 above), the currently selected set of devices will be kept connected with the user in order to prevent excessive flipping during boundary areas. The user continues to communicate with the person through the CCTV 22, the speaker 36 and the microphone 40. The user now sees the person's back.

Now assume that the user has moved further down the corridor to 0.2L right from the elevator 16. The system updates the scores of the devices, as shown in Table 4 below:

TABLE 4

| Device | “D” | Scoring formula | Score |
|---|---|---|---|
| CCTV 22 | 0.7 L | $1 - \frac{2 D}{L}$ | −0.4 |
| CCTV 24 | 0.3 L | $1 - \frac{2 D}{L}$ | 0.4 |
| CCTV 26 | — | 1 | — |
| CCTV 28 | — | 1 | — |
| Speaker 34 | $\frac{M}{2} - 0.2 L$ | $1 - \frac{2 D}{M}$ | $0.4 \frac{L}{M}$ |
| Speaker 36 | $\frac{M}{2} + 0.2 L$ | $1 - \frac{2 D}{M}$ | $- 0.4 \frac{L}{M}$ |
| Microphone 38 | $\frac{M}{2} - 0.2 L$ | $1 - \frac{2 D}{M}$ | $0.4 \frac{L}{M}$ |
| Microphone 40 | $\frac{M}{2} + 0.2 L$ | $1 - \frac{2 D}{M}$ | $- 0.4 \frac{L}{M}$ |

Let us assume that

$$( 0.4 \frac{L}{M} ) > 0.2 .$$

### The set of device with the highest scores continue to be the CCTV 24, the speaker 34 and the microphone 38. However, now that the scores of the currently selected set of devices

$$( - 0.4 and - 0.4 \frac{L}{M} )$$

have fallen below their respective thresholds (i.e. −0.3), the new set of devices will be selected. The system will then reconnect the CCTV 24 to the user's video monitor, the speaker 34 to the user's microphone and the microphone 38 to the user's speaker. The user will thus see a flip of video image and he now communicates with the person through the speaker 34 and the microphone 38 in the room 10, and he sees the person's face on the video monitor.

Now assume that the person enters the room 10. The motion detector 18 will be triggered, and the system determines that the person is now located in the middle of the room 10, and thus all devices restricted to the corridor 14 or the room 12 will not be considered.

Scores will be updated as shown in the following Table 5.

TABLE 5

| Device | “D” | Scoring formula | Score |
|---|---|---|---|
| CCTV 22 | — | $1 - \frac{2 D}{L}$ | — |
| CCTV 24 | — | $1 - \frac{2 D}{L}$ | — |
| CCTV 26 | — | 1 | 1 |
| CCTV 28 | — | 1 | — |
| Speaker 34 | 0 | $1 - \frac{2 D}{M}$ | 1 |
| Speaker 36 | M | $1 - \frac{2 D}{M}$ | −1 |
| Microphone 38 | 0 | $1 - \frac{2 D}{M}$ | 1 |
| Microphone 40 | M | $1 - \frac{2 D}{M}$ | −1 |

Since the CCTV 22 will no longer be considered (since it is out of sight), its threshold will not be used and the system automatically reconnects the CCTV 26, the current highest-score CCTV, to the user's video monitor. The user will thus see a flip of video image to the inside of the room 10, and he continues to communicate with the person through the speaker 34 and the microphone 38 in the room 10, since they continue to own the highest scores.

Other devices are also connected with the system to enable the user to execute pre-defined or pre-scripted actions. For example, when the user sees that the person has approached the room 10, he may press a key or issue a command and the system will undertake a series of actions, such as unlocking the door to the room 10 and turning on the lights in the room 10. Another possible series of remote commands that the user may issue to the system may, for example, be turning off the lights and re-locking the door after the person leaves the room 10.

In addition, the user may remotely command the system to turn on a television (TV) 46 and to connect it to a video camera pointing at himself. The person being monitored will therefore be able to conduct a video conference with the user when the person is in the room 10. Similarly, the person being monitored will be able to video conference with the user via a television (TV) 48 in the room 12, if the person is in the room 12.

In a nut-shell, an auto location-tracking system according to the present invention allows a user to maintain an interactive communication with a person being monitored, even though the person is free to roam around a large premises, while at the same time the user may remotely perform, through the system, pre-defined or pre-scripted sequences of actions based on such interactive communication.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A location tracking system for tracking the location of at least one moving object, including:
a plurality of location sensing devices adapted to assess the location of said object;
at least two signal receivers adapted to capture signals of and/or relating to said object;
an output device adapted to be connected with and receive signals from only one of said at least two signal receivers at a time for output; and
means adapted to connect said output device with said signal receivers with the higher/highest score of suitability, as calculated in a pre-determined manner.

2. A system according to claim 1 wherein said signal receivers are adapted to capture visual and/or audio signals of and/or relating to said object.

3. A system according to claim 2 wherein said signal receivers comprise at least two closed circuit television cameras.

4. A system according to claim 2 wherein said signal receivers comprise at least two microphones.

5. A system according to claim 1 wherein said score of suitability is calculated in accordance with a pre-defined formula.

6. A system according to claim 1 wherein said output device comprises at least a visual display unit.

7. A system according to claim 1 wherein said output device comprises at least a speaker.

8. A system according to claim 1 further including a plurality of signal output devices adapted to output signals to said object.

9. A system according to claim 8 wherein said signal output devices are adapted to output audio and/or visual signals to said object.

10. A system according to claim 8 further including at least one further signal receiver adapted to be connected with and transmit signals to only one of said plurality of signal output devices at a time.

11. A system according to claim 10 including means adapted to connect said further signal receiver with the audio signal output device with the higher/highest score of suitability, as calculated in a pre-determined manner.

12. A system according to claim 1 wherein said connecting means is adapted to connect the output device with the signal receiver with the higher/highest score of suitability as calculated in said predetermined manner only if the score of suitability of the currently connected signal receiver falls below a pre-determined level.

13. A system according to claim 11 wherein said connecting means is adapted to connect the signal receiver with the signal output device with the higher/highest score of suitability as calculated in said pre-determined manner only if the score of suitability of the currently connected signal output device falls below a pre-determined level.

14. A system according to claim 13 wherein said signal output devices comprise at least two speakers.

15. A system according to claim 13 wherein said signal output devices comprise at least two television sets.

16. A system according to claim 1 further including a data processing apparatus.

17. A method of operating a location tracking system for tracking the location of at least one moving object, including the steps of:
(a) providing a plurality of location sensing devices adapted to assess the location of said object;
(b) providing at least two signal receivers adapted to capture signals of and/or relating to said object;
(c) providing an output device adapted to be connected with and receive signals from only one of said at least two signal receivers at a time for output;
(d) calculating, in a pre-determined manner, a score of suitability for each of said at least two signal receivers; and
(e) connecting said output device with the signal receiver with the higher/highest score of suitability.

18. A method according to claim 17 wherein said signal receivers are adapted to capture visual and/or audio signals of and/or relating to said object.

19. A method according to claim 18 wherein said signal receivers comprise at least two closed circuit television cameras.

20. A method according to claim 18 wherein said signal receivers comprise at least two microphones.

21. A method according to claim 17 wherein said score of suitability is calculated in accordance with a pre-defined formula.

22. A method according to claim 17 wherein said output device comprises at least a visual display unit.

23. A method according to claim 17 wherein said output device comprises at least a speaker.

24. A method according to claim 17 further including a plurality of signal output devices adapted to output signals to said object.

25. A method according to claim 24 wherein said plurality of signal output devices are adapted to output audio and/or visual signals to said object.

26. A method according to claim 24 further including at least one further signal receiver adapted to be connected with and transmit signals to only one of said plurality of signal output devices at a time.

27. A method according to claim 26 including means adapted to connect said further signal receiver with the signal output device with the higher/highest score of suitability, as calculated in a pre-determined manner.

28. A method according to claim 17 wherein said connecting means is adapted to connect the output device with the signal receiver with the higher/highest score of suitability as calculated in said pre-determined manner only if the score of suitability of the currently connected signal receiver falls below a pre-determined level.

29. A method according to claim 27 wherein said connecting means is adapted to connect the signal receiver with the signal output device with the higher/highest score of suitability as calculated in said pre-determined manner only if the score of suitability of the currently connected signal output device falls below a pre-determined level.

30. A method according to claim 29 wherein said signal output devices comprise at least two speakers.

31. A method according to claim 29 wherein said signal output devices comprise at least two television sets.

32. A method according to claim 17 further including a data processing apparatus.
